(19) United States
(12) Patent Application Publication
(10) Pub. No.: US 2012/0047019 A1
(43) Pub. Date: Feb. 23, 2012

(54) APPARATUS, METHOD, AND ADVERTISING SERVER FOR PROVIDING MOBILE ADVERTISING THROUGH MOBILE BROADCASTING NETWORK

(75) Inventors: Seok-Hoon Choi, Seoul (KR); Jon-Hyo Lee, Gyeonggi-do (KR); Sung-Oh Hwang, Gyeonggi-do (KR)

(73) Assignee: SAMSUNG ELECTRONICS CO., LTD., Suwon-si, Gyeonggi-do (KR)

(21) Appl. No.: 13/265,007

(22) PCT Filed: Mar. 30, 2010
(86) PCT No.: PCT/KR2010/001943

§ 371 Date: Oct. 18, 2011

(30) Foreign Application Priority Data
Apr. 21, 2009 (KR) 10-2009-0034731

(51) Int. Cl. G06Q 30/02

(52) U.S. Cl. 705/14.64

(57) ABSTRACT

Disclosed is a method for providing a mobile advertising service using a mobile broadcasting network. The method includes the steps of: creating and providing, by a BCAST server, a service guide to which advertisement information is applied to a BCAST client when a MobAd server (Ad Server) provides the advertisement information to the BCAST Server which handles a broadcast service; and requesting, by an advertising engine (Ad engine), the BCAST client to provide a desired advertisement when the Ad server notifies the Ad engine of an object advertisement, and receiving the requested advertisement from the BCAST client.

### TECHNICAL FIELD

The present invention relates to a mobile advertising system for providing differentiated and personalized mobile advertising (MobAd) service, and more particularly to an apparatus, method, and advertising server for providing a user-personalized mobile advertising service through the use of a mobile broadcasting network, and a system therefor.

### BACKGROUND ART

The mobile communication market has continuously met requirements for the production of new services through the recombination or unification of existing technologies. With the development of communication and broadcast technologies, current broadcast systems or mobile communication systems provide a broadcast service through a mobile terminal (hereinafter, referred to simply as a “terminal”), such as a mobile phone or a Personal Digital Assistant (PDA).

In addition to potential and actual market demands, rapidly increasing user demands for multimedia services, enterprisers' strategies to provide a new service such as a broadcast service beyond the existing voice service, and interests of Information Technology (IT) companies that are enhancing mobile communication businesses in response to consumer demands have enabled the convergence between a mobile communication service and the Internet Protocol (IP) to become a big stream in the development of next generation mobile communication technology.

Meanwhile, Open Mobile Alliance (OMA) is an organization that studies the standards for interaction between individual mobile solutions, and mainly serves to establish standards for various applications relating to mobile games, Internet services, etc. Particularly, among the working groups of the OMA, the Open Mobile Alliance Requirement Working Group (OMA REQ) and Open Mobile Alliance Content Delivery Working Group (OMA CD) are studying the technical standards for a mobile advertising (MobAd) service.

### DISCLOSURE OF INVENTION

### Technical Problem

As described above, a user-personalized advertising service may be provided in a mobile advertising system, wherein it is necessary to diversify the communication scheme in order to provide the advertising service to more users. Accordingly, the mobile advertising system is required to be combined with a communication scheme which enables advertising services to be transferred to a wider range of users, and if the advertising services are provided in mutually different communication schemes, a more differentiated and personalized advertising service can be provided to the users. If advertisement can be provided through a mobile broadcasting network, as an example of the communication schemes, the scope of provision of advertisement may be further expanded.

### Solution to Problem

Accordingly, the present invention provides an apparatus, method and advertising server for providing a user-personalized mobile advertising service through the use of a mobile broadcasting network in order to provide the user-personalized advertising service to a wider range of users.

In accordance with an aspect of the present invention, there is provided an apparatus for providing a mobile advertisement using a mobile broadcasting network, the apparatus including: a BCAST client for, when a BCAST server creates a service guide to which advertisement information is applied in response to a request including the advertisement information and an advertisement from an advertisement server, receiving the advertisement and the service guide created by the BCAST server; and an advertisement engine for providing the advertisement server with user's contextualization and personalization information in advance, selecting at least one advertisement from among one or more object advertisements when receiving a notification message reporting that the one or more object advertisements exist from the advertisement server, and receiving the selected advertisement from the BCAST client.

In accordance with another aspect of the present invention, there is provided a method for providing, by a mobile advertisement provision apparatus including a BCAST client and an advertisement engine, a mobile advertisement using a mobile broadcasting network, the method including the steps of: providing an advertisement server with user's contextualization and personalization information in advance; when a BCAST server creates a service guide to which advertisement information is applied in response to a request including the advertisement information and an advertisement from an advertisement server, receiving a notification message reporting that one or more object advertisements exist from the advertisement server; and selecting at least one advertisement from among the object advertisements and receiving the selected advertisement.

In accordance with yet another aspect of the present invention, there is provided an advertisement server for providing a mobile advertisement using a mobile broadcasting network through a process, which includes: receiving user's contextualization and personalization information from an advertisement engine in advance; transmitting a request message requesting creation of a service guide, to which advertisement information is applied, to a BCAST server; receiving a response message reporting that the service guide has been created from the BCAST server; selecting an advertisement reception target audience using the user's contextualization and personalization information provided in advance when receiving the response message; creating a notification message reporting that an advertisement matching the selected advertisement reception target audience exists, based on the response message; and transmitting the created notification message to the advertisement engine.

### ADVANTAGEOUS EFFECTS OF INVENTION

Since a mobile advertisement (MobAd) enterpriser can implement the method of the present invention using the existing OMA CAST technology, the advertising service can be provided through the broadcasting network, without using a separate other technology. In addition, according to the present invention, since the mobile advertising service is provided to a plurality of users through the broadcasting network, it is possible to increase the efficiency of resource utilization.

### BRIEF DESCRIPTION OF DRAWINGS

The above and other aspects, features and advantages of the present invention will be more apparent from the following detailed description taken in conjunction with the accompanying drawings, in which:

FIG. 1 is a diagram illustrating a logical architecture of the BCAST Working Group of the OMA;

FIG. 2 is a diagram illustrating the configuration and interfaces of a mobile advertising system to which the present invention is applied;

FIG. 3 is a diagram illustrating the configuration of a system made by combining logical entities of mobile advertising (MobAd) and mobile broadcasting (BCAST) according to an exemplary embodiment of the present invention;

FIG. 4 is a flowchart explaining an operation of providing a mobile advertising service to the user using an OMA BCAST protocol;

FIG. 5 is a flowchart explaining the operation of an Ad server according to an exemplary embodiment of the present invention; and

FIG. 6 is a flowchart explaining the operation of an Ad engine according to an exemplary embodiment of the present invention.

### MODE FOR THE INVENTION

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

The following description will be given on exemplary embodiments of the present invention for achieving the aforementioned technical objective. For convenience, a description of the present invention will be made herein using the names of the entities defined in the 3rd Generation Partnership Project (3GPP), which is the 3rd mobile communication standard, or defined in the MobAd of Open Mobile Alliance (OMA), which is a standard organization for applications of mobile terminals. However, the stated standards and entity names thereof are not intended to limit the scope of the present invention, and the present invention can be applied to other systems having a similar technical background.

The present invention proposes a method for providing a mobile adverting service through the use of a mobile broadcasting network. Specifically, a method according to the present invention includes a step of creating and providing, by a BCAST server, a service guide (hereinafter, referred to as an “Ad information-embedded service guide”) to which advertisement information is applied to a BCAST client when a MobAd server (hereinafter, simply referred to as “Ad Server”) provides the advertisement information to the BCAST Server which handles a broadcast service; and a step of requesting, by an advertising engine (Ad engine), the BCAST client to provide a desired advertisement when the Ad server notifies the Ad engine of an object advertisement, and receiving the requested advertisement from the BCAST client.

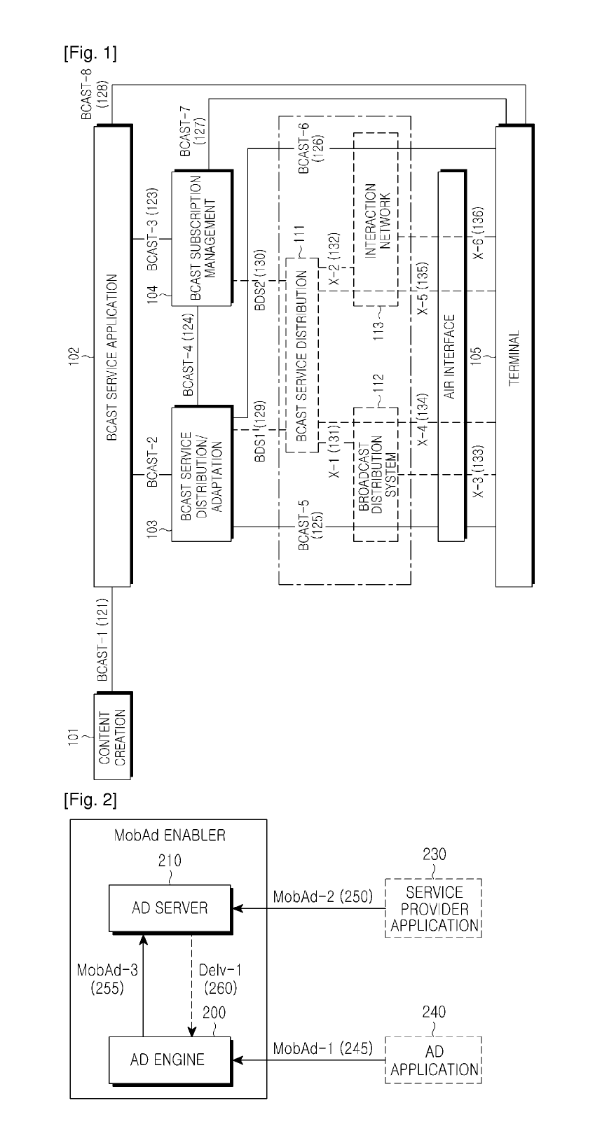

Before a detailed description of the present invention, the basic configuration of a mobile broadcasting system used in the present invention will be described. To this end, reference is made to FIG. 1, which is a diagram illustrating a logical architecture of the BCAST Working Group of the OMA that establishes standard technologies of an application layer and its lower transport layer with respect to a mobile broadcast service.

A detailed description will first be made of logical entities shown in FIG. 1. A content creation (CC) entity 101 provides contents which are the basis of a BCAST service, wherein the contents include a file for a normal broadcast service, for example, data for movie, audio, and video. In addition, the content creation entity 101 provides a BCAST service application entity 102 with attributes for the contents for creating a service guide and determining a transport bearer to deliver the service.

The BCAST service application entity 102 receives the data for the BCAST service from the content creation entity 101 and processes the received data in the format suitable for media encoding, content protection, and interactive service. In addition, the BCAST service application entity 102 provides the attributes for the contents provided from the content creation entity 101 to a BCAST service distribution/adaptation entity 103 and a BCAST subscription management entity 104.

The BCAST service distribution/adaptation entity 103 performs file/streaming delivery, service collection, service protection, service guide creation/delivery, and service notification operations using the BCAST service data provided from the BCAST service application entity 102. In addition, the BCAST service distribution/adaptation entity 103 adapts the service to be suitable for a broadcast distribution system (BDS) 112.

The BCAST subscription management entity 104 manages service provisioning such as a subscription/charging-related function of a BCAST service user, provisioning of information used for the BCAST service, and a terminal receiving the BCAST service, in a hardware/software manner.

A terminal 105 receives contents and program support information, such as service guide and content protection, and provides a broadcast service to the user. A BDS service distribution entity 111 delivers a mobile broadcast service to a plurality of terminals through mutual communication with the broadcast distribution system 112 and an interaction network 113.

The broadcast distribution system 112 delivers a mobile broadcast service over a broadcast channel, wherein the mobile broadcast service may include, for example, a Multimedia Broadcast Multicast Service (MBMS) of 3rd Generation Project Partnership (3GPP), a Broadcast Multicast Service (BCMCS) of 3rd Generation Project Partnership 2 (3GPP2) which is the 3rd generation synchronous mobile communication standard group, a DVB-Handheld (DVB-H) defined by Digital Video Broadcasting (DVB) which is the digital broadcasting standard group, and an IP-based broadcasting/communication network. The interaction network 113 provides an interaction channel, and can be, for example, a cellular network.

A description will now be made of reference points that are connection paths between the aforementioned logical entities. The reference points have a plurality of interfaces according to their purposes. The interfaces are used for communication between two or more logical entities for a predetermined purpose, wherein the message format and protocol for the communication are applied.

BCAST-1 121 is a transmission path for contents and content attributes, and BCAST-2 122 is a transmission path for a content-protected or content-unprotected BCAST service, attributes of the BCAST service, and content attributes. BCAST-3 123 is a transmission path for attributes of a BCAST service, content attributes, user preference/subscription information, a user request, and a response to the request. BCAST-4 124 is a transmission path for a notification message, attributes used for a service guide, and keys used for content protection and service protection.

BCAST-5 125 is a transmission path for a protected BCAST service, an unprotected BCAST service, a content-protected BCAST service, a content-unprotected BCAST service, BCAST service attributes, content attributes, a notification, a service guide, security materials such as Digital Right Management (DRM) Right Object (RO) and key values used for BCAST service protection, and all data and signals transmitted through a broadcast channel. BCAST-6 126 performs the same role as BCAST-5 125. BCAST-7 127 is a transmission path for service provisioning, subscription information, device management, and user preference information transmitted through an interaction channel for control information related to receipt of security materials, such as DRM RO and key values, used for BCAST service protection. BCAST-8 128 is a transmission path through which user data for a BCAST service is interacted.

BDS-1 129 is a transmission path for a protected BCAST service, an unprotected BCAST service, BCAST service attributes, content attributes, a notification, a service guide, and security materials, such as DRM RO and key values, used for BCAST service protection. BDS-2 130 is a transmission path for service provisioning, subscription information, device management, and security materials, such as DRM RO and key values, used for BCAST service protection.

X-1 131 is a reference point between the BDS service distribution entity 111 and the broadcast distribution system 112. X-2 132 is a reference point between the BDS service distribution entity 111 and the interaction network 113. X-3 133 is a reference point between the broadcast distribution system 112 and the terminal 105. X-4 134 is a reference point between the BDS service distribution entity 111 and the terminal 105 over a broadcast channel. X-5 135 is a reference point between the BDS service distribution entity 111 and the terminal 105 over an interaction channel. X-6 136 is a reference point between the interaction network 113 and the terminal 105.

The components of a mobile advertising system using a mobile broadcasting system, as described above, and the operations thereof will now be described with reference to FIG. 2. FIG. 2 is a diagram illustrating the configuration and interfaces of a mobile advertising system to which the present invention is applied.

The mobile advertising system includes an advertising engine (Ad engine) 200 and an Advertising server (Ad server) 210, which are mandatory components, and interfaces provided by the mandatory components. Components and interfaces, other than the aforementioned mandatory components and interfaces, are illustrated only for showing the cooperation relationship in the mobile advertising system, so a detailed description thereof will be omitted.

The Ad engine 200 is a component of the mobile advertising system, and is located in a terminal. The Ad engine 200 cooperates with an Ad application 240 and is used to access the Ad server 210. Such an Ad engine 200 corresponds to an Ad client, and supports a useful function to approach a mobile advertising service provided from the Ad application 240. In addition, the Ad engine 200 performs an Ad acquisition and delivery function, an Ad selection function, an Ad interaction result handling function (Ad Metrics Handling function), a user/service/device data handling function, and the like.

Here, the Ad acquisition and delivery function serves to receive an advertisement from the Ad server 210, to store the received advertisement, to update a received advertisement, to receive an advertisement request from the Ad application 240, and to provide an advertisement corresponding to the request. The Ad selection function serves to select an appropriate advertisement through the use of advertisement selection criteria, input data in an advertisement request message provided from the Ad application 240, contextualization and personalization information (C&PI), etc. The Ad interaction result handling function serves to receive an interaction result from the Ad application 240, to combine the interaction result with information (e.g. a measurement time of the interaction result) which the Ad engine 200 has known, to check if the received interaction result is fraudulence, to express a result of the checking, and to provide an interaction result to the Ad server 210. The user/service/device data handling function serves to handle dynamic/static information of a user/device, and to provide mobile advertising service-related data, e.g. rule, policy, etc.

The Ad server 210 is a component of the mobile advertising system, and is located on a network. The Ad server 210 is used to provide advertisements to the Ad engine 200 and a service provider application 230. The Ad server 210 supports an Ad selection function, an Ad delivery function, an Ad interaction result handling function, a user/service/device data handling function, etc.

The Ad selection function provides a function of selecting an appropriate advertisement through the use of contextualization and personalization information (C&PI), Ad metadata, an Ad rule (i.e. MobAd rule), etc. The Ad delivery function serves to deliver Ad metadata, an advertisement, an Ad campaign, reference of Ad metadata, an advertisement, or an Ad campaign, and an indicator indicating that there is no appropriate advertisement, to the Ad engine 200 and the service provider application 230. The Ad interaction result handling function serves to collect an advertising exposure frequency and user response information, received from the Ad engine 200 and the service provider application 230, to collect and handle interaction result-related information (e.g. information on advertising exposure time), and to combine a plurality of collected interaction results. The user/service/device data handling function serves to handle user contextualization and personalization information, to handle mobile advertising service-related data, to handle groups for Ad provision, to handle Ad channels, and to handle advertisements and Ad metadata.

The Ad application 240 is an external entity executed by a terminal, and is used for requesting the Ad engine 200 to send an advertisement, receiving an advertisement from the Ad engine 200, displaying the received advertisement to the user, and providing an Ad interaction result to the Ad engine 200. The Ad application 240 may include, for example, a messaging client, a web browser, a gaming client, etc.

The service provider application 230 is an external entity, and is used for requesting the Ad server 210 to send an advertisement, receiving an advertisement from the Ad server 210, displaying the received advertisement to the user, together with contents, and providing an Ad interaction result to the Ad server 210. The service provider application 230 may include, for example, web portals, a multimedia service (MMS) relay/server, a short message service center (SMSC), a gaming server, etc.

Contextualization and personalization Resources (C&PR) (not shown), are storages for user-related information, and is out of the scope of mobile advertisement. The C&PR may include, for example, the user's personal characteristics, preference, current circumstances, etc. The C&PR is used to identify requirements of the user upon Ad selection.

Interfaces used between logical entities as shown in FIG. 2 are as follows.

MobAd-1 245 is an interface between the Ad engine 200 and the Ad application 240, and is provided by the Ad engine 200 to the Ad application 240. MobAd-1 245 is used when the Ad application 240 requests the Ad engine 200 to deliver an advertisement and an Ad-associated identifier, or provides the Ad engine 200 with an Ad interaction result.

MobAd-2 250 is an interface between the Ad server 210 and the service provider application 230, and is provided by the Ad server 210 to the service provider application 230. MobAd-2 250 is used when the service provider application 230 requests an advertisement or provides an Ad interaction result, or when the Ad server 210 provides the service provider application 230 with an Ad response and an associated Ad identifier.

MobAd-3 255 is an interface between the Ad server 210 and the Ad engine 200, and is provided by the Ad server 210 to the Ad engine 200. MobAd-3 255 is used when the Ad engine 200 requests the Ad server 210 to send an advertisement and an Ad-associated identifier, or provides the Ad server 210 with an Ad interaction result.

Delv-1 260 is an optional interface provided by the Ad engine 200. The Ad engine 200 receives an advertisement and Ad metadata via Delv-1 260 through the use of underlying push and/or a broadcast delivery device. The Ad server 210 uses Delv-1 260 when delivering an advertisement, an Ad notification, and a service notification to the Ad engine 200.

As described above, when the user requests an advertisement through the Ad application, or when the Ad engine requests a desired advertisement to the Ad server using/referring to available user's contextualization and personalization information, the Ad server selects and provides an advertisement corresponding to a requested condition to the Ad engine. For example, when advertisements are provided to women spectators in their twenties and thirties in the XX baseball field, users having mutually similar contextualization (i.e. Location: XX baseball field) or personalization (i.e. women in their twenties and thirties) information receive the advertisements. In this case, when consideration is taken into a case where the users receive the same advertisement, 2N (wherein “n” represents the number of advertisement requestors) number of transmission/reception times is created according to the number of users. This derives the necessity of efficient use of resources.

Accordingly, in consideration of this respect, the present invention proposes a method of providing a mobile advertising service through the use of mobile broadcasting in a mobile advertising system in order to provide more users with personalized advertising service. To this end, an OMA BCAST protocol is used the mobile advertising system according to the present invention.

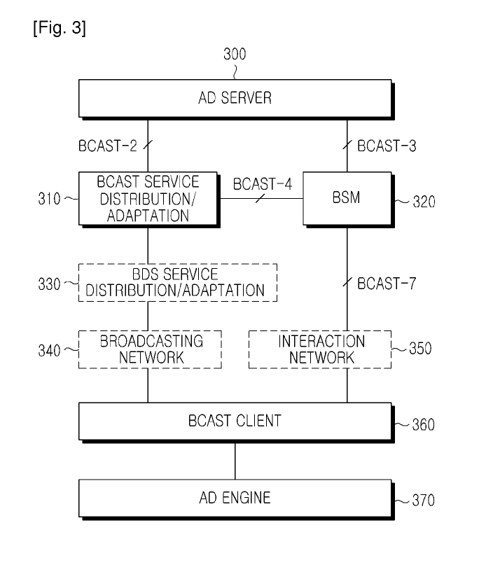

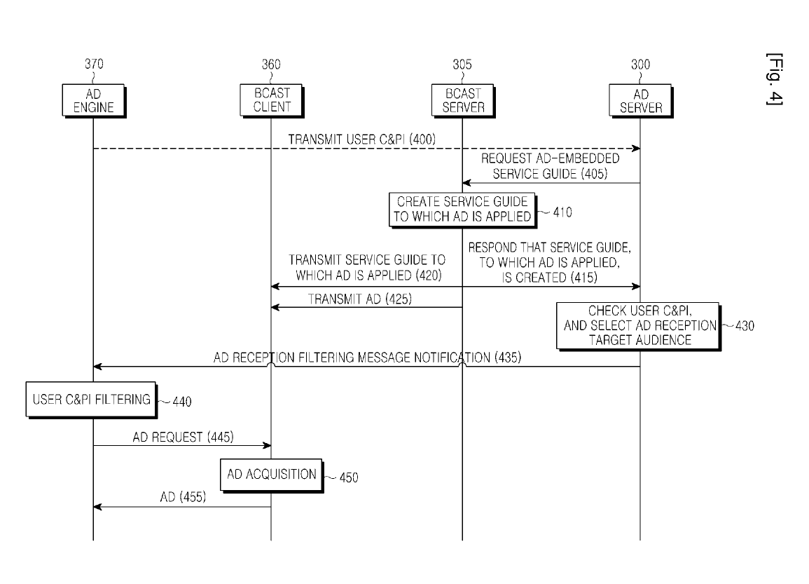

A system for providing a mobile advertising service using mobile broadcasting, as described above, will now be described with reference to FIG. 3. FIG. 3 is a diagram illustrating the configuration of a system made by combining logical entities used for mobile advertising (MobAd) and mobile broadcasting (BCAST) according to an exemplary embodiment of the present invention. Therefore, the logical entities shown in FIG. 3 are the same as those shown in FIGS. 1 and 2.

Referring to FIG. 3, an Ad server 300 performs the role of the BCAST service application entity 102 shown in FIG. 1, and operates in cooperation with a BCAST service distribution/adaptation entity 310 and a BCAST subscription management entity (BSM) 320.

Also, in the terminal 105 shown in FIG. 1, an Ad engine (i.e. MobAd engine) 370 and a BCAST client 360 are included. Here, MBA-x is a reference point between the Ad engine 370 and the BCAST client 360. The Ad engine 370 transmits a mobile advertising request message to the BCAST client 360 through the reference point, and receives an advertisement from the BCAST client 360. The operations of the remaining components are the same as those described with reference to FIGS. 1 and 2. When a mobile advertising service is provided to multiple users through such a mobile broadcasting network, it is possible to increase the efficiency of resource utilization.

FIG. 4 is a flowchart explaining an operation of providing a mobile advertising service to the user using an OMA BCAST protocol. In FIG. 4, it is assumed that the Ad engine 370 provides the Ad server 300 with user's contextualization and personalization information in advance, as shown in step 400, or that the Ad server 300 has already stored the user's contextualization and personalization information. Here, the user's contextualization information includes, for example, location, preference, a keyword, etc., and the personalization information include, for example, age, sex, a residential district, etc. The following description will be given about an example where the Ad server 300 stores information “the City Hall,” “iPod,” etc. as the contextualization and personalization information.

Referring to FIG. 4, the Ad server 300 transmits a request message, that requests a BCAST server 305 to create an Ad-embedded service guide in step 405. The request message is used for the Ad server 300 to provide the BCAST server 305 with all advertisement information and advertisements stored in the Ad server 300. In addition, the request message plays a role of allowing the BCAST server 305 to create an Ad information-embedded service guide, and to transmit advertisement through the use of a BCAST protocol. For example, all Ad information and advertisements, such as a TGI City Hall discount event, iPod, restaurant, sports shoes, mobile phones, etc., can be included in the request message and can be transmitted to the BCAST server 305.

Then, the BCAST server 305 creates an Ad-embedded service guide using and/or referring to received Ad information in step 410. Subsequently, the BCAST server 305 transmits a response for reporting that the Ad-embedded service guide has been created to the Ad server 300 in step 415. This response plays a role of allowing the Ad server 300 to select a target terminal to receive advertisement, and to prepare to transmit a list of advertisements mapped to the target terminal to the Ad engine 370.

While transmitting such a response, the BCAST server 305 creates a BCAST channel for transmitting a received advertisement through an OMA BCAST protocol. That is, at least one dedicated BCAST channel for only advertisement transmission is created. Thereafter, the BCAST server 305 transmits the created Ad-embedded service guide to the BCAST client 360 in step 420, and transmits an advertisement to the BCAST client 360 in step 425. In this case, the advertisement and the Ad-embedded service guide are transmitted through mutually different sessions.

Meanwhile, the Ad server 300, which has received the response in step 415, checks user contextualization and personalization information and selects advertisement reception target audiences in step 430. Also, the Ad server 300 transmits a notification message, which includes information on advertisements suitable for the target audiences selected according to step 430, i.e. information on object advertisements or advertisement filtering mapped to the target audiences, to the Ad engine 370 in step 435. The notification message is a filtering message for advertisement reception, and is directly delivered from the Ad server 300 to the Ad engine 370 through an external way, such as the HTTP protocol, instead of the OMA BCAST protocol. For example, when the Ad server 300 selects an advertisement reception target audience whose contextualization and personalization information is set to “the City Hall” and “iPod,” the Ad server 300 notifies the selected advertisement reception target audience, using a notification message, that TGI City Hall discount event and iPod advertisements are being provided through a service guide.

When receiving such a notification message, the Ad engine 370 filters the user contextualization and personalization information using the notification message in step 440. In this case, when receiving the notification message, the Ad engine 370 determines if user contextualization and personalization information stored in the Ad engine 370 is updated. After such an update, if there is an advertisement satisfying the updated user contextualization and personalization information, the Ad engine 370 transmits an advertisement request message to the BCAST client 360 in step 445. For example, when the current location of the Ad engine 370 does not correspond to the City Hall, and the iPod advertisement satisfies the current contextualization and personalization information, the Ad engine 370 requests only the iPod advertisement. Then, the BCAST client 360 acquires the advertisement based on the request in step 450, and then transfers the acquired advertisement to the Ad engine 370 in step 455. That is, the Ad engine 370 receives only the iPod advertisement.

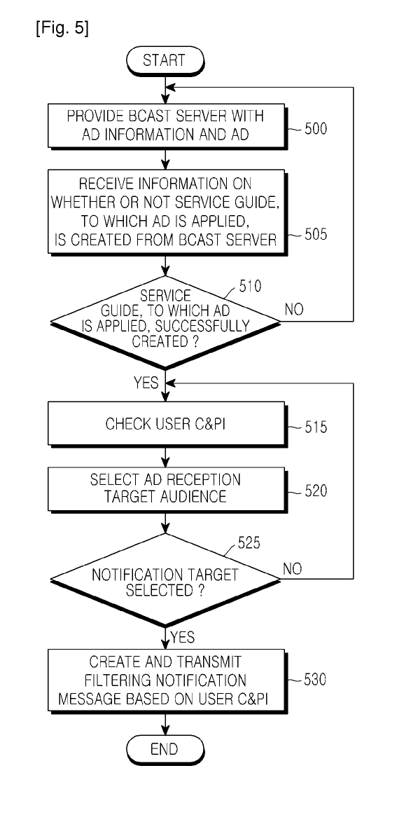

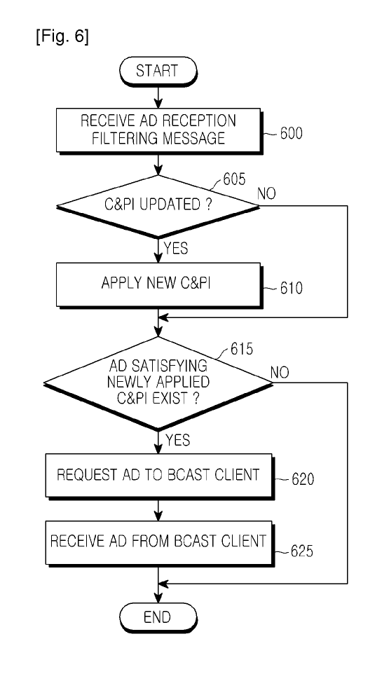

The operation of the Ad server 300 shown in FIG. 4 will now be described in more detail. To this end, reference is made to FIG. 5, which is a flowchart explaining the operation of the Ad server according to an exemplary embodiment of the present invention.

Referring to FIG. 5, the Ad server 300 provides the BCAST server 305 with all advertisement information and advertisements, which are stored in the Ad server 300, in step 500. To this end the Ad server 300 transmits a message requesting creation of an Ad-embedded service guide. As an example, Table 1 below shows a message requesting creation of an Ad-embedded service guide, wherein the message includes advertisement information and advertisements to use/refer to when the Ad-embedded service guide is created. However, the format of the message is not limited to that shown in Table 1.

TABLE 1

| Name | Description |
|---|---|
| Ad-embedded | Identifier of Ad-embedded service guide creation request |
| service guide | message, Unique in all the world |
| creation request | |
| ID | |
| Ad Server ID | Identifier of MobAd server requesting Ad-embedded |
| | service guide to be created |
| Ad Metadata | Metadata of advertisement, including Ad ID, category, |
| | type, format, expiration date, genre, targeted audience, |
| | and the like of corresponding advertisement |
| Ad | Advertisement |

A request message as shown in Table 1 includes an Ad-embedded service guide creation request ID used as an identifier of the Ad-embedded service guide creation request message, an Ad server ID which is an identifier of an Ad server requesting an Ad-embedded service guide to be created, Ad metadata representing the characteristics of a corresponding advertisement, and an advertisement which is an advertisement content provided by an advertiser to the user.

Of them, the Ad server ID is used to identify each Ad server when a plurality of Ad servers requests an Ad-embedded service guide to be created. Also, the request message includes Ad metadata, wherein one advertisement necessarily has one piece of Ad metadata explaining the characteristics of the corresponding advertisement. In this case, the Ad metadata includes an Ad ID, a type, a format, an expiration date, a genre, a targeted audience, and the like of the corresponding advertisement.

Therefore, according to the present invention, multiple pieces of Ad metadata and Ad information stored in the Ad server are included in the request message and are provided.

After transmitting such a request message, the Ad server 300 receives a response message representing whether or not an Ad information-embedded service guide has been created from the BCAST server 305 in step 505, and then determines if an Ad-embedded service guide has been successfully created in step 510. Here, the response message may be configured as shown in Table 2, but the present invention is not limited thereto.

TABLE 2

| Name | Description |
|---|---|
| Ad-embedded | Identifier of response message to Ad-embedded |
| service guide | service guide creation request, and the |
| creation | same as identifier of Ad-embedded |
| response ID | service guide creation request message |
| State | Representing state information, such as success, |
| | failure, cause of failure, etc., with respect to |
| | Ad-embedded service guide creation request |
| Category | Information classified by Ad metadata and |
| | advertisement |
| BCAST service ID | Identifier of BCAST channel to transmit |
| | advertisement |
| BCAST content ID | Identifier of advertisement re-defined in BCAST |
| Ad ID | Ad identifier provided from Ad server to BCAST |
| | server, and ID corresponding to BCAST |
| | content ID |

In Table 2, the Ad-embedded service guide creation response ID is used as an identifier of the Ad-embedded service guide creation response message, and is the same as the Ad-embedded service guide creation request ID.

The state represents state information, such as success, failure, the cause of failure, etc., with respect to an Ad-embedded service guide creation request. If an Ad-embedded service guide creation request fails, the following items are not included in the response message to be provided.

The category is information classifying advertisements, wherein the BCAST server determines the category by making reference to Ad metadata received from the Ad server. Here, corresponding information may be configured in various forms according to business models. The category may be classified, for example, according to genres, types, targeted audiences (e.g. over 18 years old), and the like of advertisements.

The BCAST service ID is an identifier allocated for a BCAST server to transmit an advertisement received from an Ad server through a BCAST protocol, and is a BCAST Ad channel identifier.

The BCAST content ID is an identifier allocated for mapping an Ad identifier, received from an Ad server, to an identifier which can be recognized by BCAST protocol. The BCAST content ID is an identifier which can be recognized by the BCAST protocol, and is used when a BCAST client acquires a corresponding advertisement.

The Ad server 300 checks the state of Table 2 in order to determine if the Ad-embedded service guide has been successfully created in step 510.

When the Ad-embedded service guide creation has failed as a result of the determination, the Ad server 300 returns to step 500 and again provides the BCAST server 305 with all Ad information and advertisements stored in the Ad server 300. In contrast, when Ad-embedded service guide has been successfully created, the Ad server 300 checks user contextualization and personalization information, received or stored in advance, in step 515, and selects an advertisement reception target audience in step 520 based on the checked information.

When a notification target audience has been selected in step 525, the Ad server 300 creates a filtering notification message for advertisement reception based on the user contextualization and personalization information, and provides the filtering notification message to the Ad engine 370 in step 530. According to an exemplary embodiment of the present invention, three types of filtering notification messages for advertisement reception will now be described with reference to Tables 3 to 5, respectively, but the present invention is not limited thereto.

TABLE 3

| Name | Description |
|---|---|
| Filtering ID for Ad | Identifier of filtering notification message for |
| reception | advertisement reception, Unique in all the world |
| Category | Information classified by Ad metadata and |
| | advertisement |
| BCAST service ID | Identifier of BCAST channel to transmit |
| | advertisement |
| BCAST content ID | Advertisement identifier re-defined in BCAST |

In Table 3, the filtering ID for Ad reception is an item allocated for identifying the filtering information for advertisement reception, which is transmitted from the Ad server to the Ad engine, and is used as a message identifier. The category, the BCAST service ID, and BCAST content ID items are the same as those included in the Ad-embedded service guide creation response message.

The filtering notification message for advertisement reception, as shown in Table 3, is used when there are both an advertisement and filtering information for advertisement reception, which are suitable for an advertisement receiver selected by the Ad server according to the contextualization and personalization information. Accordingly, the Ad server 300 can report an information suitable for a selected advertisement reception target audience through the use of a BCAST service ID, a BCAST content ID, etc, and can report information for advertisement filtering through the use of the category, etc.

TABLE 4

| Name | Description |
|---|---|
| Filtering noti- | Identifier of filtering notification message for |
| fication ID for | advertisement reception, Unique in all the world |
| Ad reception | |
| BCAST service ID | Identifier of BCAST channel to transmit |
| | advertisement |
| BCAST content ID | Advertisement identifier re-defined in BCAST |

In Table 4, the filtering ID for advertisement reception is an item allocated for identifying the filtering information for advertisement reception, which is transmitted from the Ad server to the Ad engine, and is used as a message identifier. The filtering notification message for advertisement reception, as shown in Table 4, is used when there is an advertisement suitable for an advertisement receiver, whom the Ad server selects based on pre-received user contextualization and personalization information.

TABLE 5

| Name | Description |
|---|---|
| Filtering ID for | Identifier of filtering notification message for |
| Ad reception | advertisement reception, Unique in all the world |
| Category | Information classified according to advertisement |
| | metadata |

In Table 5, the filtering ID for advertisement reception is an item allocated for identifying the filtering information for advertisement reception, which is transmitted from the Ad server to the Ad engine, and is used as a message identifier. The filtering notification message for advertisement reception, as shown in Table 5, is used for the Ad server to notify the Ad engine of filtering information for advertisement reception, which is suitable for an advertisement receiver selected according to pre-received user contextualization and personalization information.

When the Ad server 300 cannot select an advertisement reception notification target audience with pre-received user contextualization and personalization information in step 525, the Ad server 300 requests the user contextualization and personalization information to be updated, checks the updated user contextualization and personalization information, and then determines an advertisement reception notification target audience.

Meanwhile, the operation of the Ad engine 370 shown in FIG. 4 will now be described in detail. To this end, reference is made to FIG. 6, which is a flowchart explaining the operation of the Ad engine according to an exemplary embodiment of the present invention.

Referring to FIG. 6, the Ad engine 370 receives an advertisement reception filtering message which is a notification message, as shown in Tables 3 to 5, in step 600. Then, the Ad engine 370 compares contextualization and personalization information included in the received message with the current information stored in the Ad engine 370, and checks changed information. That is, the Ad engine 370 compares user contextualization and personalization information currently stored in the Ad engine 370 with the information included in the notification message. When it is determined in step 605 that it is necessary to update the current user contextualization and personalization information, new contextualization and personalization information is applied in step 610. Thereafter, it is determined if there is an advertisement satisfying the newly-applied contextualization and personalization information in step 615. Specifically, an advertisement satisfying the current user contextualization and personalization information updated in the Ad engine exists with respect to the BCAST content ID, the BCAST service ID, the category, or all the three items, the Ad engine 370 transmits an advertisement request message to the BCAST client 360 in step 620. An example of the advertisement request message is shown in Table 6, but the present invention is not limited to the format shown in Table 6.

TABLE 6

| Name | Description |
|---|---|
| Ad request | Identifier of advertisement request message, |
| message ID | Unique in all the world |
| BCAST service ID | Identifier of BCAST channel to transmit |
| | advertisement |
| BCAST content ID | Advertisement identifier re-defined in BCAST |

In Table 6, the Ad request message ID is an item allocated for identifying advertisement request information delivered from the Ad engine to the BCAST client, and is used as a message identifier. The BCAST service ID item and BCAST content ID item are the same as those included in the Ad-embedded service guide creation response message. The advertisement request message, as shown in Table 6, is used when the Ad engine requests the BCAST client to provide a specific advertisement.

Another example of the advertisement request message is shown in Table 7 below.

TABLE 7

| Name | Description |
|---|---|
| Ad request | Identifier of advertisement request message, |
| message ID | Unique in all the world |
| Category | Information classified according to |
| | advertisement metadata |

In Table 7, the Ad request message ID is an item allocated for identifying advertisement request information delivered from the Ad engine from the BCAST client, and is used as a message identifier. The category item is the same as that included in the Ad-embedded service guide creation response message. The advertisement request message, as shown in Table 7, is used when the Ad engine requests the BCAST client to provide an advertisement using the category as filtering criteria for advertisement selection.

Accordingly, the BCAST client 360 acquires only advertisements satisfying the items included in the advertisement request message received from the Ad engine, from among received advertisement channels. In this case, a response message to the advertisement request message, which the Ad engine has received from the BCAST client, may have a format as shown in Table 8, but the present invention is not limited to the format shown in Table 8.

TABLE 8

| Name | Description |
|---|---|
| Ad request | Identifier of advertisement request response message, |
| response | The same as Ad request message ID |
| message ID | |
| Ad | Advertisement suitable for requested item |

The response message, as shown in Table 8, includes an advertisement suitable for one or more items requested by the Ad engine, and includes an advertisement request response message ID, which is a message identifier indicating that the message is a response to the advertisement request message.

Accordingly, the Ad engine 370 receives an advertisement acquired from the BCAST client 360 in step 625, so that the Ad engine 370 can obtain only one or more desired advertisements through a response message, as shown in Table 8.

While the invention has been shown and described with reference to certain exemplary embodiments thereof, it will be understood by those skilled in the art that various changes in form and details may be made therein without departing from the spirit and scope of the invention as defined by the appended claims.

1. An apparatus for providing a mobile advertisement using a mobile broadcasting network, the apparatus comprising:
a BCAST client for, when a BCAST server creates a service guide to which advertisement information is applied in response to a request including the advertisement information and an advertisement from an advertisement server, receiving the advertisement and the service guide created by the BCAST server; and
an advertisement engine for providing the advertisement server with user's contextualization and personalization information in advance, selecting at least one advertisement from among one or more object advertisements when receiving a notification message reporting that the one or more object advertisements exist from the advertisement server, and receiving the selected advertisement from the BCAST client.

2. The apparatus as claimed in claim 1, wherein the BCAST client transmits/receives a message to/from the BCAST server using an OMA BCAST protocol, and the advertisement engine transmits/receives a message to/from the advertisement server using an HTTP protocol.

3. The apparatus as claimed in claim 1, wherein the notification message comprises information for advertisement filtering or the one or more object advertisements which match the user's contextualization and personalization information provided in advance.

4. The apparatus as claimed in claim 3, wherein, when receiving the notification message, the advertisement engine compares user contextualization and personalization information currently stored in the advertisement engine with the information for advertisement filtering included in the notification message, and selects an advertisement satisfying the current user contextualization and personalization information based on a result of the comparison.

5. A method for providing, by a mobile advertisement provision apparatus comprising a BCAST client and an advertisement engine, a mobile advertisement using a mobile broadcasting network, the method comprising the steps of:
providing an advertisement server with user's contextualization and personalization information in advance;
when a BCAST server creates a service guide to which advertisement information is applied in response to a request including the advertisement information and an advertisement from an advertisement server, receiving a notification message reporting that one or more object advertisements exist from the advertisement server; and selecting at least one advertisement from among the object advertisements and receiving the selected advertisement.

6. The method as claimed in claim 5, further comprising a step of receiving, by the BCAST client, the advertisement and the service guide to which the advertisement information is applied.

7. The method as claimed in claim 5, wherein the notification message comprises information for advertisement filtering or the one or more object advertisements which match the user's contextualization and personalization information provided in advance.

8. The method as claimed in claim 7, wherein the step of receiving the selected advertisement comprises the steps of:
comparing, by the advertisement engine, user contextualization and personalization information currently stored in the advertisement engine with the information for advertisement filtering included in the notification message;
selecting an advertisement satisfying the current user contextualization and personalization information based on a result of the comparison; and
receiving the selected advertisement from the BCAST client.

9. An advertisement server for providing a mobile advertisement using a mobile broadcasting network through a process, which comprises:
receiving user's contextualization and personalization information from an advertisement engine in advance;
transmitting a request message requesting creation of a service guide, to which advertisement information is applied, to a BCAST server;
receiving a response message reporting that the service guide has been created from the BCAST server;
selecting an advertisement reception target audience using the user's contextualization and personalization information provided in advance when receiving the response message;
creating a notification message reporting that an advertisement matching the selected advertisement reception target audience exists, based on the response message; and
transmitting the created notification message to the advertisement engine.

10. The advertisement server as claimed in claim 9, wherein the request message comprises an identifier indicating that the message is a request message, an identifier of the advertisement server, advertisement metadata including an advertisement identifier, and an advertisement.

11. The advertisement server as claimed in claim 10, wherein the response message comprises an identifier indicating that the message is a response message to the request message, state information of the service guide creation, a category, an identifier of a BCAST channel to transmit an advertisement, another advertisement identifier obtained by re-defining the advertisement identifier provided from the advertisement server in BCAST, and the advertisement identifier provided from the advertisement server.

12. The advertisement server as claimed in claim 11, wherein the notification message comprises an identifier indicating that the message is a notification message, and comprises at least one among the category, the identifier of the BCAST channel, and said another advertisement identifier re-defined in the BCAST.
